(19) United States
(12) Patent Application Publication
(10) Pub. No.: US 2025/0303981 A1
(43) Pub. Date: Oct. 2, 2025

(54) VEHICLE STRUCTURE

(71) Applicant: TOYOTA JIDOSHA KABUSHIKI KAISHA, Aichi-ken (JP)

(72) Inventor: Ryosuke FUKUI, Aichi-gun, Aichi-ken (JP)

(21) Appl. No.: 19/045,555

(22) Filed: Feb. 5, 2025

(30) Foreign Application Priority Data
Mar. 29, 2024 (JP) 2024-057902

(51) Int. Cl. B60R 13/08; B62D 25/16

(52) U.S. Cl. CPC B60R 13/0861; B62D 25/16

(57) ABSTRACT

A vehicle structure is provided with: a frame member integrally molded by die casting and having a shape of an open cross-section with an opening in at least one direction; a liner member disposed between the frame member and a tire, and attached to the frame member to form a closed cross-section or a semi-closed cross-section with a portion of the open cross-section of at least a part of the frame member; and a sound-absorbing member disposed in the closed cross-section or the semi-closed cross-section.

### CROSS-REFERENCE TO RELATED APPLICATION

This application claims priority to Japanese Patent Application No. 2024-057902 filed on Mar. 29, 2024, incorporated herein by reference in its entirety.

### BACKGROUND

### 1. Technical Field

The disclosure relates to a vehicle structure.

### 2. Description of Related Art

Japanese Unexamined Patent Application Publication No. 2012-8458 discloses a vehicle structure in which a fender liner is provided with through-holes, and a membrane or plate-shaped vibrator is fixed to one surface of the fender liner on the opposite side of a tire in a vibratable manner to cover the through-holes. In the vehicle structure described in JP 2012-8458 A, sound absorption is performed by resonating sound in an air chamber surrounded by the vibrator and the fender liner.

### SUMMARY

Vibration and engine noise from internal combustion engines are being replaced by motor noise, with high-frequency sounds becoming more dominant, while noise from tires is becoming more noticeable due to improved quietness. Meanwhile, in the vehicle structure, priority is given to enhancing product appeal by reducing the minimum turning radius through an increased turning angle of the tires, which limits the space available for sound absorption structures. In the vehicle structure described in JP 2012-8458 A, another space is required for installing the air chamber, leaving room for improvement in the use of space for sound absorption.

The disclosure provides a vehicle structure capable of effectively utilizing a dead space and obtaining a sound-absorbing effect.

A vehicle structure according to a first aspect is provided with: a frame member integrally molded by die casting and having a shape of an open cross-section with an opening in at least one direction; a liner member configured to be disposed between the frame member and a tire, and attached to the frame member to form a closed cross-section or a semi-closed cross-section with a portion of the open cross-section of at least a part of the frame member; and a sound-absorbing member disposed in the closed cross-section or the semi-closed cross-section.

In the vehicle structure according to the first aspect, when the liner member is attached to the frame member between the frame member and the tire, the sound-absorbing member is disposed in the closed or semi-closed cross-section formed with the portion of the open cross-section of the frame member, so that another space for placement of the sound-absorbing member is not required. Therefore, a dead space formed when the liner member is attached to the frame member can be effectively utilized, obtaining a sound-absorbing effect to absorb noise and the like from the tire. Note that the “semi-closed cross-section” as used herein refers to a structure in which, when a closed cross-section is formed by the liner member and the portion of the open cross-section of the frame member, the structure does not necessarily have a complete closed cross-section, but constitutes an overall closed cross-section structure, even though a gap, opening, or similar feature may be partially present.

In the vehicle structure according to the second aspect, in the configuration according to the first aspect, the sound-absorbing member may be attached to the liner member.

In the vehicle structure according to the second aspect, since the sound-absorbing member is attached to the liner member, while noise propagates in the order of the tire, the liner member, and the open cross-section of the frame member, resonance and vibration in the closed or semi-closed cross-section formed by the liner member and the portion of the open cross-section of the frame member can be reduced more quickly.

In the vehicle structure according to the third aspect, in the configuration according to the first aspect, the sound-absorbing member may be attached to the frame member.

In the vehicle structure according to the third aspect, since the sound-absorbing member is attached to the frame member, the liner member can be attached to the frame member after the sound-absorbing member has been attached to the frame member. This can improve the case of attachment of the sound-absorbing member.

In the vehicle structure according to the fourth aspect, in the configuration according to the first aspect, the sound-absorbing member may be attached to both the liner member and the frame member.

In the vehicle structure according to the fourth aspect, since the sound-absorbing member is attached to both the liner member and the frame member, the sound-absorbing member can be attached more firmly in the closed or semi-closed cross-section.

In the vehicle structure according to the fifth aspect, in the configuration according to the first aspect, the sound-absorbing member may be configured to be disposed at a position overlapping the tire in a top view.

In the vehicle structure according to the fifth aspect, since the sound-absorbing member is disposed at a position overlapping the tire in the top view, the sound-absorbing member can be disposed in a portion that has a large impact on an occupant in a vehicle cabin, thereby improving the sound-absorbing effect on the occupant.

In the vehicle structure according to the sixth aspect, in the configuration according to any of the first aspect to the fifth aspect, the frame member may be a frame portion extending along a vehicle front-rear direction in a wheelhouse.

In the vehicle structure according to the sixth aspect, since the frame member is a frame portion extending in the vehicle front-rear direction along the wheelhouse, the sound-absorbing member can be disposed in a wider range facing the tire. This can further improve the sound-absorbing effect.

In the vehicle structure according to the seventh aspect, in the configuration according to the sixth aspect, the frame member may include two or more chambers partitioned by a rib in a vehicle-height direction, and the sound-absorbing member may be disposed in an upper chamber including at least a chamber located on an uppermost side in the vehicle-height direction among the two or more chambers.

In the vehicle structure according to the seventh aspect, the frame member may include two chambers partitioned by the rib in the vehicle-height direction, and the sound-absorbing member is disposed in the chamber partitioned by the rib. Therefore, the sound-absorbing member can be positioned by the rib. Further, since the sound-absorbing member is disposed in the upper chamber including at least the chamber located on the uppermost side in the vehicle-height direction among the two or more chambers, the sound-absorbing member can be placed on the side closer to the occupant in the vehicle cabin, thereby further improving the sound-absorbing effect on the occupant.

In the vehicle structure according to the eighth aspect, in the configuration according to the seventh aspect, the frame member may include two chambers partitioned in the vehicle-height direction by the rib, and the sound-absorbing member may be disposed in the chamber located on an upper side in the vehicle-height direction.

In the vehicle structure according to the eighth aspect, since the two chambers partitioned by the rib are arranged in the vehicle-height direction, the sound-absorbing member can be positioned by the rib. Further, since the sound-absorbing member is disposed in the chamber located on the upper side in the vehicle-height direction, the sound-absorbing member can be placed on the side closer to the occupant in the vehicle cabin, thereby further improving the sound-absorbing effect on the occupant.

In the vehicle structure according to the ninth aspect, in the configuration according to the second aspect or the fourth aspect, the liner member may include a rib on the surface on the side of where the sound-absorbing member is attached.

In the vehicle structure according to the ninth aspect, since the liner member includes the rib on the surface on the side where the sound-absorbing member is attached, the attachment position of the sound-absorbing member can be set using the rib when the sound-absorbing member is attached, thereby improving the ease of attachment of the sound-absorbing member.

As described above, the vehicle structure according to the disclosure can effectively utilize the dead space and obtain the sound-absorbing effect.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating an example of a vehicle front structure including a frame member of a vehicle structure according to an embodiment of the disclosure;

FIG. 2 is a right side view schematically illustrating an example of the vehicle front structure in FIG. 1;

FIG. 3 is a front sectional view schematically illustrating an example of the vehicle front structure in FIG. 1 near a tire;

FIG. 4 is a side view schematically illustrating an example of the vehicle front structure in FIG. 1 near the tire when the tire is mounted;

FIG. 5 is a bottom view schematically illustrating an example of the vehicle front structure in FIG. 1;

FIG. 6 is a side view schematically illustrating Modification 1 of an attachment position of a sound-absorbing member;

FIG. 7 is a side view schematically illustrating Modification 2 of the attachment position of the sound-absorbing member;

FIG. 8 is a front sectional view of the main part, schematically illustrating Modification 3 of the attachment position of the sound-absorbing member; and

FIG. 9 is a front sectional view of the main part, schematically illustrating Modification 4 of the attachment position of the sound-absorbing member.

### DETAILED DESCRIPTION OF EMBODIMENTS

A vehicle structure according to an embodiment of the disclosure will be described below with reference to the accompanying drawings. In the present specification and the drawings, components having substantially the same functional configuration are denoted by the same reference numerals to avoid redundancy. In the drawings, an arrow FR, shown as appropriate in each figure, indicates the front side in the vehicle front-rear direction, and an arrow UP indicates the upper side in the vehicle-height direction. An arrow LH indicates the left side in the vehicle-width direction, and an arrow IN indicates the inside in the vehicle-width direction. Hereinafter, when a description is given simply using the front-rear direction, the vertical direction, and the lateral direction, this shall indicate the front and rear in the vehicle front-rear direction, the top and bottom in the vehicle-height direction, and the left and right in the vehicle left-right direction (vehicle-width direction) unless otherwise specified. 30

### Configuration of Vehicle Front Structure

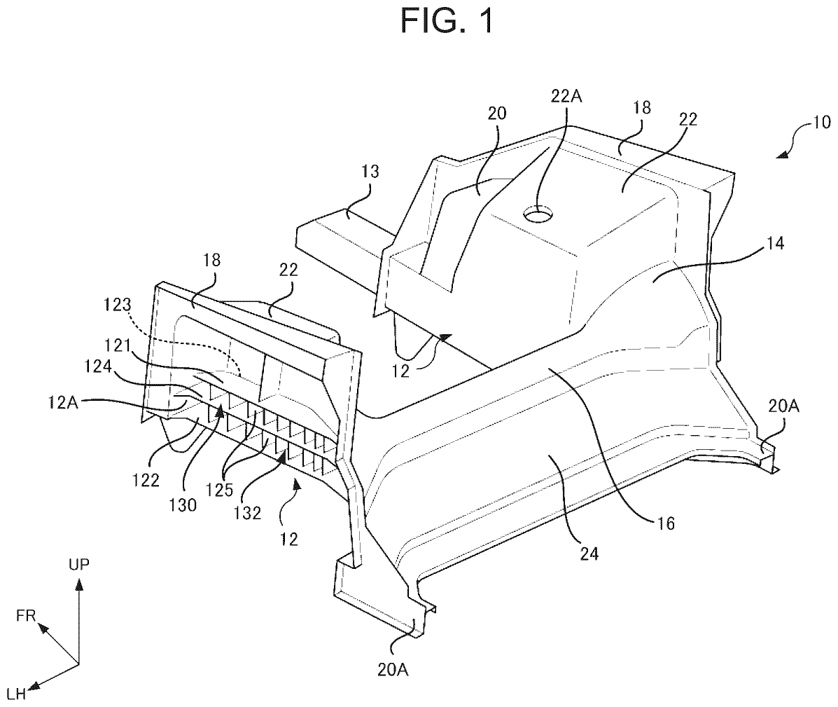

First, a configuration of a vehicle front structure 10 will be described as an example of a vehicle structure according to an embodiment of the disclosure. FIG. 1 is a perspective view schematically illustrating an example of the vehicle front structure 10.

FIG. 1 schematically illustrates the vehicle front structure 10 showing a frame of a front portion of a vehicle. In the present embodiment, the vehicle is, as an example, a battery electric vehicle (BEV), a fuel cell electric vehicle (FCEV), a hybrid electric vehicle (HEV), or a plug-in hybrid electric vehicle (PHEV), which travels using power generated by a power unit.

As illustrated in FIG. 1, the vehicle front structure 10 includes a pair of left and right front side members 12 that are front frame members of the vehicle and are disposed on both sides of the vehicle front in the vehicle-width direction. The front side members 12 extend in the vehicle front-rear direction, and the end portion of the front side member 12 on the vehicle rear side is connected to a cross member 16. The vehicle front end portion of the front side member 12 is connected to a front bumper reinforcement (illustration omitted; hereinafter referred to as “bumper RF”) disposed along the vehicle-width direction. In the present embodiment, as an example, the front side member 12 includes a crash box 13 serving as an energy-absorbing member at the front end portion connected to the bumper RF. Note that the crash box 13 is described as a separate component from the bumper RF in the present embodiment, but the two may be integrated into a single structure. In FIG. 1, the crash box 13 is illustrated only on the right side, but in reality, the crash box 13 is also provided on the left side.

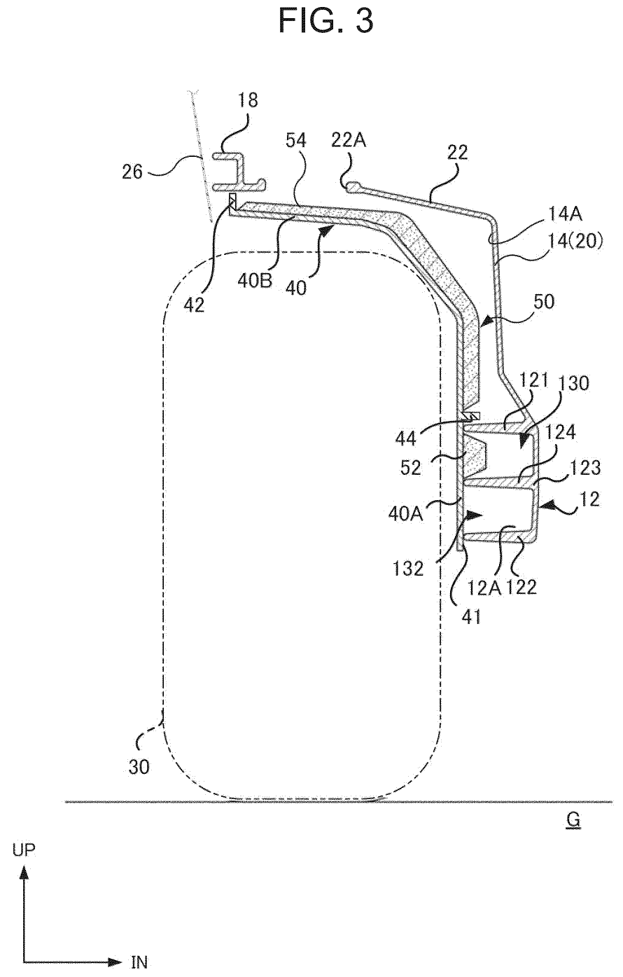

Wheelhouses 14, where tires 30 (cf. FIG. 3) serving as wheels are disposed, are respectively arranged on the outer sides of the pair of front side members 12 in the vehicle-width direction, and the left and right wheelhouses 14 are connected by the cross member 16. The front side member 12 is provided in the wheelhouse 14, on an extension of a side member (not illustrated) that constitutes the lower lateral frame of the vehicle.

An apron upper member 18 is arranged on each of the rear sides of the left and right front side members 12 on the outside in the vehicle-width direction and on the upper side in the vehicle-height direction. The apron upper member 18 is a frame member constituting the upper lateral frame of the vehicle front structure 10 and extends in the vehicle front-rear direction along the front side member 12. The front side member 12 and the apron upper member 18 each have a substantially rectangular open cross-sectional shape with an opening on the outside in the vehicle-width direction, in other words, a substantially rectangular cross-sectional shape that is open on the outside in the vehicle-width direction. In each figure, the opening in the apron upper member 18 is not illustrated, but the apron upper member 18 has a shock-absorbing structure, which will be described later, in substantially the same manner as the front side member 12.

A pair of left and right fender aprons 20 are arranged on the outside of the front side member 12 in the vehicle-width direction and on the inside of the apron upper member 18 in the vehicle-width direction. The fender apron 20 has an upper end joined to the apron upper member 18 and a lower end joined to the front side member 12, and a suspension tower 22 and a wheelhouse 14 are formed integrally. The suspension tower 22 is disposed above the vehicle on the outside of the front side member 12 in the vehicle-width direction, and the lower side of the suspension tower 22 is joined to the fender apron 20. A through-hole 22A through which the upper end of a suspension (not illustrated) is disposed is formed in the upper end surface of the suspension tower 22. The fender apron 20 is formed to bulge inward in the vehicle-width direction, and the bulged portion forms a wheelhouse 14 in which the tire 30 is housed rotatably.

The dash panel 24 is disposed on the vehicle rear side of the front side member 12 and between the pair of left and right apron upper members 18. The dash panel 24 is a member to partition a space (not illustrated) where a power unit is housed and a vehicle cabin (not illustrated), and extends in the vehicle-width direction and the vehicle-height direction with the plate thickness direction as the vehicle front-rear direction. The dash panel 24 has an end portion in the vehicle-width direction connected to the fender apron 20, and an upper end connected to the cross member 16.

A rear end portion 20A of the fender apron 20 on the rear side of the wheelhouse 14 in the vehicle front-rear direction extends along the vehicle front-rear direction and is connected to a rocker (not illustrated) that constitutes a frame of a vehicle body side portion.

The suspension tower 22 is provided protruding substantially in a cylindrical shape from the wheelhouse 14 of the fender apron 20 toward the upper side of the vehicle. The suspension tower 22 houses a shock absorber and a spring constituting a suspension (not illustrated) that supports the tire serving as a front wheel housed in the wheelhouse 14.

In the vehicle front structure 10 of the present embodiment, as an example, the pair of front side members 12, the wheelhouse 14, the cross member 16, the apron upper member 18, the fender apron 20, the suspension tower 22, and the dash panel 24 illustrated in FIG. 1 are integrally molded by aluminum die casting. Note that the crash box 13 may or may not be integrally molded as the vehicle front structure 10. The vehicle front structure 10 may be integrally molded in each of the left and right halves.

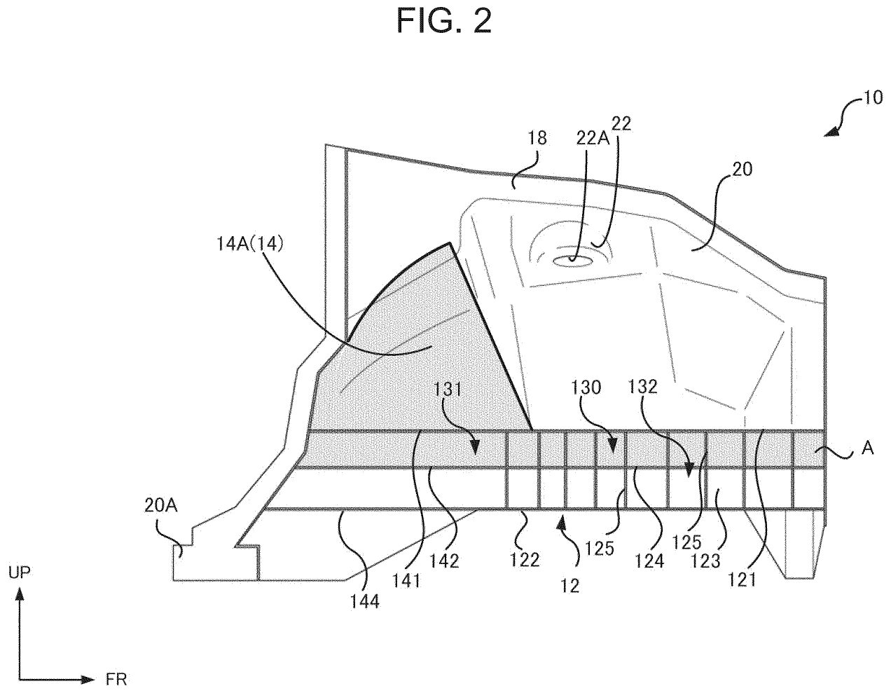

Next, the shock-absorbing structure provided in the front side member 12 will be described. FIG. 2 is a right side view schematically illustrating an example of the vehicle front structure 10 in FIG. 1. As illustrated in FIGS. 1 and 2, the front side member 12 of the present embodiment extends along the vehicle front-rear direction (a load input direction of an impact load) as described above, and is provided with an opening 12A on the outside in the vehicle-width direction. The front side member 12 includes an upper wall portion 121, a lower wall portion 122, and an inner wall portion 123 that is disposed on the inside in the vehicle-width direction and connects the inner end portions of the upper wall portion 121 and the lower wall portion 122 in the vehicle-width direction.

In the present embodiment, as an example, the front side member 12 is provided with a partition wall 124 serving as a rib that constitutes two chambers, adjacent in the vehicle-height direction, at a substantially central portion in the vehicle-height direction. The front side member 12 includes two chambers on the upper and lower sides, an upper chamber 130 and a lower chamber 132, partitioned in the vehicle-height direction by the partition wall 124.

The front side member 12 includes a plurality of vertical partition walls 125 serving as ribs that are arranged in a row to constitute a plurality of compartments in the vehicle front-rear direction. The front side member 12 includes the plurality of compartments partitioned in the vehicle front-rear direction by the vertical partition walls 125. That is, the upper chamber 130 and the lower chamber 132 each include a plurality of compartments arranged in the vehicle front-rear direction.

As described above, the front side member 12 is provided with the plurality of compartments arranged in the vehicle front-rear direction and the vehicle-height direction. Therefore, when an impact load is applied to the front side member 12 (along the vehicle front-rear direction), breaking loads are generated corresponding to the number of compartments, and the impact energy is absorbed in the process.

FIG. 3 is a front sectional view schematically illustrating an example of the vehicle front structure 10 illustrated in FIG. 1 near the tire 30. As illustrated in FIG. 3, the vehicle front structure 10 includes a liner member 40 disposed between the front side member 12 and the tire 30 and formed of a plate member. The liner member 40 includes a first liner member 40A that is extended in the vehicle-height direction at a position facing the opening 12A of the front side member 12. The liner member 40 also includes a second liner member 40B that is extended from the upper end of the first liner member 40A along the curvature in the wheelhouse 14.

The first liner member 40A is attached to form a closed cross-section with a portion of the open cross-section of the front side member 12. Specifically, the closed cross-section is formed by one surface 41 of the liner member 40, opposite to the tire 30, coming into contact with the upper wall portion 121 and the lower wall portion 122 of the front side member 12, as well as the end surface of the partition wall 124 on the opening 12A side. In the present embodiment, the end surface of the partition wall 124 on the opening 12A side is also in contact with the one surface 41 of the liner member 40, but the disclosure is not limited thereto. The end surface of the partition wall 124 does not have to be in contact with the one surface 41 of the liner member 40.

In the present embodiment, the first liner member 40A is attached to form a closed cross-section with the portion of the open cross-section of the front side member 12, but attachment does not have to be performed to form a strictly closed cross-section. For example, attachment may be performed to form a semi-closed cross-section where a gap, an opening, or the like is partially present.

The second liner member 40B is attached to face the inner surface 14A (the surface on the tire 30 side) of the wheelhouse 14 to form a space with the inner surface 14A. In the present embodiment, as illustrated in FIG. 2, the inner surface 14A is provided with an extended upper wall portion 141, an extended lower wall portion 144, and an extended partition wall 142 that are ribs extended from the upper wall portion 121, the lower wall portion 122, and the partition wall 124 of the front side member 12, respectively, and curved along the inner surface 14A. That is, two chambers on the upper and lower sides, partitioned in the vehicle-height direction, are also formed on the inner surface 14A of the wheelhouse 14. Although not illustrated, a plurality of ribs along the curve of the inner surface 14A may be formed on the upper side of the extended upper wall portion 141 on the inner surface 14A of the wheelhouse 14.

The second liner member 40B is attached to form a semi-closed cross-section with the inner surface 14A of the wheelhouse 14. As illustrated in FIG. 3, the through-hole 22A of the suspension tower 22 is formed on the upper end surface of the fender apron 20 that forms the wheelhouse 14. Therefore, the cross-section formed by the second liner member 40B and the inner surface 14A of the wheelhouse 14 is a semi-closed cross-section where a gap, an opening, or the like is partially present.

As illustrated in FIG. 3, the second liner member 40B includes a first rib 42 and a second rib 44 on the one surface 41 that protrude toward the inner surface 14A of the wheelhouse 14. The first rib 42 and the second rib 44 are provided for positioning a sound-absorbing member 50, which will be described later in detail.

In the present embodiment, as illustrated in FIGS. 2 and 3, the sound-absorbing member 50 is disposed between the liner member 40 and the inner surface 14A of the wheelhouse 14 and the opening 12A side of the front side member 12. As an example, the sound-absorbing member 50 is made of a resin such as polyester or acrylic, a foam such as rubber, or a porous material such as felt or glass wool. As an example, the sound-absorbing member 50 is disposed in an area illustrated by a shaded area A in FIG. 2. In the present embodiment, the sound-absorbing member 50 is attached to the liner member 40 and includes a first sound-absorbing member 52 and a second sound-absorbing member 54. Specifically, the first sound-absorbing member 52 is disposed in the closed cross-section formed by the one surface 41 of the first liner member 40A and the portion of the open cross-section of the front side member 12, that is, in the upper chamber 130 constituting the closed cross-section, and is attached to the one surface 41 of the first liner member 40A.

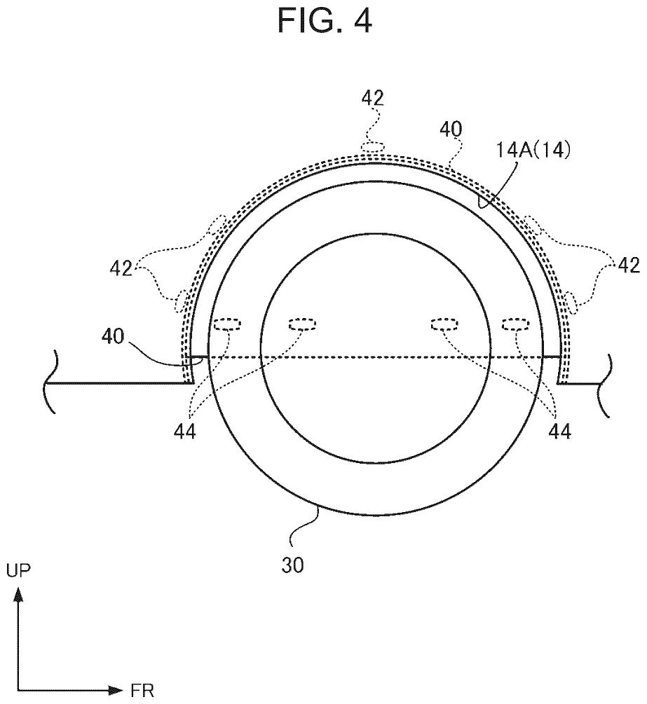

The second sound-absorbing member 54 is disposed in the semi-closed cross-section formed by the one surface 41 of the second liner member 40B and the inner surface 14A of the wheelhouse 14, that is, in the space between the one surface 41 and the inner surface 14A constituting the semi-closed cross-section, and is attached to the one surface 41 of the second liner member 40B. As illustrated in FIG. 3, the second sound-absorbing member 54 is attached between the first rib 42 and second rib 44 for positioning that are provided on the one surface 41 of the second liner member 40B. FIG. 4 is a side view schematically illustrating an example of the vehicle front structure 10 in FIG. 1 near the tire 30 when the tire is mounted.

As illustrated in FIGS. 3 and 4, as an example, five first ribs 42 are provided on the second liner member 40B along the curve of the inner surface 14A of the wheelhouse 14, that is, along the curve of the outer periphery of the tire 30. Four second ribs 44 are arranged in a row in the vehicle front-rear direction on the upper side of the upper wall portion 121 of the front side member 12. In the present embodiment, the second sound-absorbing member 54 is attached to an area surrounded by the five first ribs and the four second ribs 44. That is, the second sound-absorbing member 54 is attached along the inner surface 14A of the wheelhouse 14.

As illustrated in FIG. 4, in the present embodiment, the sound-absorbing member 50 is disposed at a position facing the upper portion of the tire 30 in the vehicle. That is, the sound-absorbing member 50 is disposed at a position overlapping the tire 30 in the vehicle-height direction. The first sound-absorbing member 52 and the second sound-absorbing member 54 are attached to the liner member 40 using an adhesive, as an example. Note that the attachment method is not limited to adhesive, and a known attachment method can be adopted.

### Actions and Effects of the Present Embodiment

Next, the actions and effects of the present embodiment will be described.

In the vehicle front structure 10 of the present embodiment, when the liner member 40 is attached to the front side member 12 between the front side member 12 and the tire 30, the sound-absorbing member 50 is disposed in the closed or semi-closed cross-section formed with a portion of the open cross-section of the front side member 12, so that another space for placement of the sound-absorbing member 50 is not required. Therefore, the dead space formed when the liner member 40 is attached to the front side member 12 can be effectively utilized, obtaining a sound-absorbing effect to absorb noise and the like from the tire 30.

In the vehicle front structure 10 of the present embodiment, since the sound-absorbing member 50 is attached to the liner member 40, while noise propagates in the order of the tire 30, the liner member 40, and the open cross-section of the front side member 12, resonance and vibration in the closed or semi-closed cross-section formed by the liner member 40 and the portion of the open cross-section of the front side member 12 can be reduced more quickly.

In the vehicle front structure 10 of the present embodiment, since the sound-absorbing member 50 is disposed at a position overlapping the tire 30 in the top view, the sound-absorbing member 50 can be disposed in a portion that has a large impact on the occupant in the vehicle cabin, thereby improving the sound-absorbing effect on the occupant.

In the vehicle front structure 10 of the present embodiment, since the front side member 12 is provided in the wheelhouse 14 on the extension of the side member and is a frame portion extending along the vehicle front-rear direction, the sound-absorbing member 50 can be disposed in a wider range facing the tire 30. This can further improve the sound-absorbing effect.

In the vehicle front structure 10 of the present embodiment, since the partition wall 124 and the extended partition wall 142 are provided as ribs that constitute two chambers in the vehicle-height direction, the sound-absorbing member 50 can be positioned by the partition wall 124 and the extended partition wall 142. Further, since the sound-absorbing member 50 is disposed in the upper chamber in the vehicle-height direction, the sound-absorbing member 50 can be placed on the side closer to the occupant in the vehicle cabin, thereby further improving the sound-absorbing effect on the occupant.

In the vehicle front structure 10 of the present embodiment, since the liner member 40 includes the first rib 42 and the second rib 44 on the one surface 41 on the side where the sound-absorbing member 50 is attached, the attachment position of the sound-absorbing member 50 can be set using the first rib 42 and the second rib 44 when the sound-absorbing member 50 is attached, thereby improving the case of attachment of the sound-absorbing member 50. That is, the first rib 42 and the second rib 44 function as positioning ribs.

### Modifications

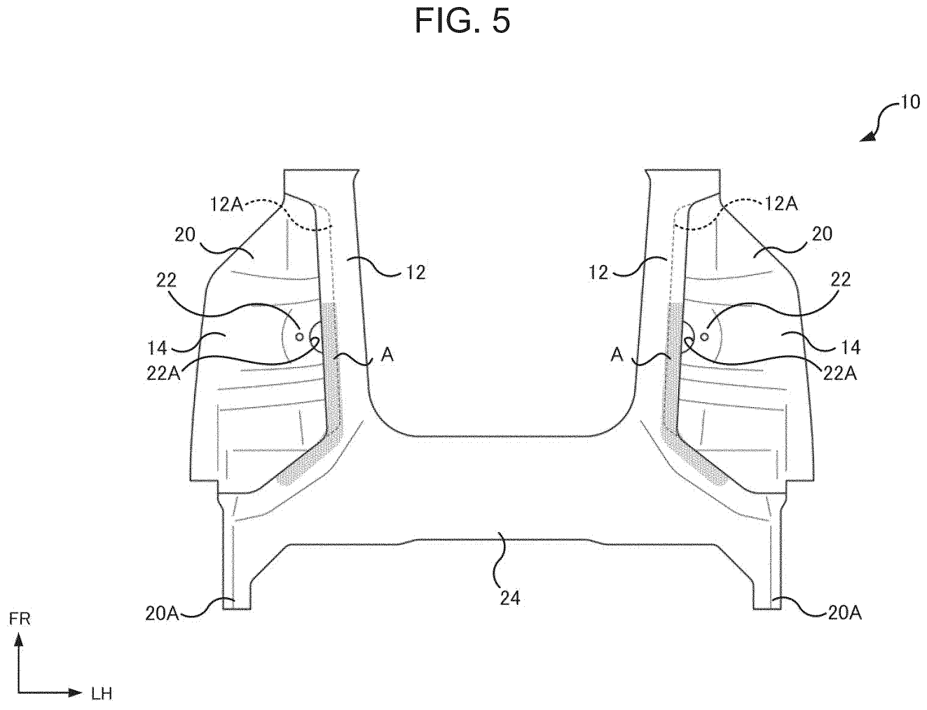

In the embodiment described above, as illustrated in FIG. 2, the sound-absorbing member 50 is attached entirely to the inner surface 14A of the wheelhouse 14 in the vehicle front-rear direction, but the disclosure is not limited thereto. FIG. 5 is a bottom view schematically illustrating an example of the vehicle front structure 10 in FIG. 1.

For example, as illustrated by a shaded area A in FIG. 5, the sound-absorbing member 50 may be disposed at least on the side closer to the vehicle cabin in the vehicle front-rear direction. That is, the sound-absorbing member 50 may be disposed not entirely in the closed cross-section of the front side member 12 (in the upper chamber 130) but only on the front side. In other words, the sound-absorbing member 50 may not be disposed on the rear side in the closed cross-section of the front side member 12 (in the upper chamber 130).

If the sound-absorbing member 50 is disposed at least on the side closer to the vehicle cabin as described above, it is possible to reduce the cost required for the sound-absorbing member 50 and improve the sound-absorbing effect on the occupant.

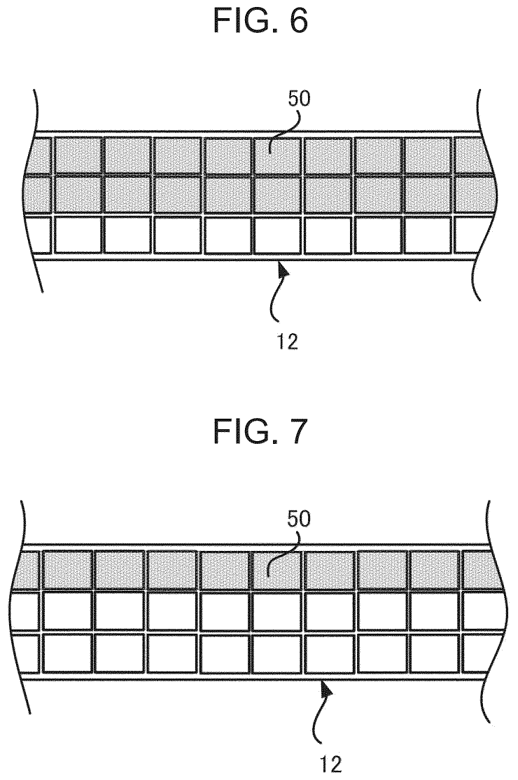

FIGS. 6 and 7 are side views schematically illustrating Modifications 1 and 2 of the attachment position of the sound-absorbing member 50, respectively. The front side member 12 of the above embodiment includes two chambers, the upper chamber 130 and the lower chamber 132, in the vehicle-height direction, but the disclosure is not limited thereto. As illustrated in FIGS. 6 and 7, when the front side member 12 includes three chambers adjacent to each other in the vehicle-height direction, the sound-absorbing member 50 may be attached in the uppermost chamber and the middle chamber, as in Modification 1 illustrated in FIG. 6. Further, as in Modification 2 illustrated in FIG. 7, the sound-absorbing member 50 may be attached only in the uppermost chamber. When the front side member 12 includes three or more chambers adjacent to each other in the vehicle-height direction, the sound-absorbing member 50 may be attached to an upper chamber including at least a chamber located in the uppermost.

In Modifications 1 and 2, the front side member 12 includes ribs that constitute three or more chambers in the vehicle-height direction, and the sound-absorbing member 50 is disposed in the chambers constituted by the ribs. Thus, the sound-absorbing member 50 can be positioned by the ribs. Further, since the sound-absorbing member 50 is disposed in the upper chamber including at least the uppermost chamber in the vehicle-height direction among the three or more chambers, the sound-absorbing member 50 can be disposed on the side closer to the occupant in the vehicle cabin, thereby further improving the sound-absorbing effect on the occupant.

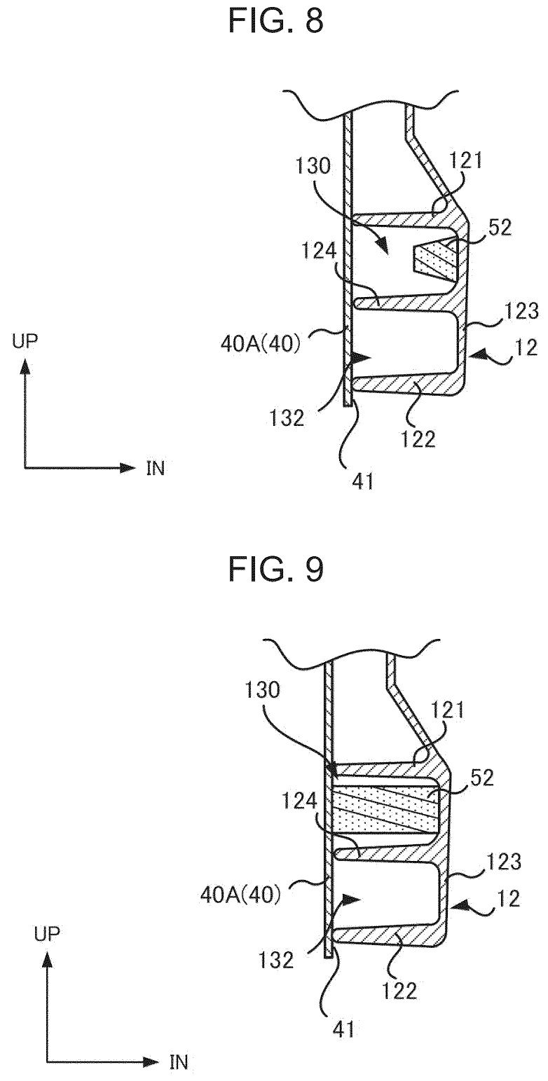

In the vehicle front structure 10 of the above embodiment, the sound-absorbing member 50 is attached to the liner members 40, but the disclosure is not limited thereto. FIGS. 8 and 9 are front sectional views of the main parts, schematically illustrating the attachment positions of the sound-absorbing members 50 in Modifications 3 and 4, respectively.

In Modification 3, as illustrated in FIG. 8, the first sound-absorbing member 52 is attached to the front side member 12. Specifically, the first sound-absorbing member 52 is attached to the surface of the inner wall portion 123 of the front side member 12 on the upper chamber 130 side. Thus, by attaching the first sound-absorbing member 52 to the front side member 12, the liner members 40 can be attached to the front side member 12 after the first sound-absorbing member 52 has been attached to the front side member 12. This can improve the case of attachment of the first sound-absorbing member 52. The second sound-absorbing members 54 may also be attached to the front side member 12.

In Modification 4, as illustrated in FIG. 9, the first sound-absorbing member 52 is attached to the liner member 40 and the front side member 12. Specifically, the inner side of the first sound-absorbing member 52 in the vehicle-width direction is attached to the surface of the inner wall portion 123 of the front side member 12 on the upper chamber 130 side. Meanwhile, the outer side of the first sound-absorbing member 52 in the vehicle-width direction is attached to the one surface 41 of the liner member 40. Thus, by attaching the first sound-absorbing member 52 to both the liner member 40 and the front side member 12, the sound-absorbing member 50 can be attached more firmly in the closed or semi-closed cross-section. Note that the second sound-absorbing member 54 may be attached to the liner member 40 and the front side member 12. The second sound-absorbing member 54 may be divided into a third sound-absorbing member attached to the liner member 40 and a fourth sound-absorbing member attached to the front side member 12.

### Remarks

Although the vehicle front structure 10 has been described as an example of the vehicle structure in the embodiment described above, the vehicle structure of the disclosure is not limited to the vehicle front structure 10 and may be a vehicle rear structure. The vehicle rear structure may have a similar structure to the vehicle front structure 10.

Although the vehicle front structure 10 is integrally molded by die casting in the embodiment described above, the disclosure is not limited thereto, and at least a frame member such as the front side member 12 may be integrally molded.

In the embodiment described above, the front side member 12 and the apron upper member 18 each have an open cross-sectional shape with an opening on the outside in the vehicle-width direction, but the disclosure is not limited thereto. At least one of the front side member 12 or the apron upper member 18 may have an open cross-sectional shape with openings both on the outside and the inside in the vehicle-width direction.

In the embodiment described above, the second liner member 40B includes five first ribs 42 and four second ribs 44, but the disclosure is not limited thereto. The number and attachment positions of the first ribs 42 and the second ribs 44 can be changed as needed depending on the size or other characteristics of the second sound-absorbing member 54 attached to the second liner member 40B.

In the embodiment described above, the second liner member 40B includes five first ribs 42 and four second ribs 44, but the disclosure is not limited thereto, and the second liner member 40B may not include first ribs 42 or second ribs 44. In particular, when the sound-absorbing member 50 is attached to the front side member 12 as in Modification 3 illustrated in FIG. 8, the first ribs 42 and the second ribs 44 are unnecessary.

The configuration of the disclosure is not limited to the embodiment described above and can be changed as needed as long as the problems can be solved.

What is claimed is:

1. A vehicle structure comprising:
a frame member integrally molded by die casting and having a shape of an open cross-section with an opening in at least one direction;
a liner member configured to be disposed between the frame member and a tire, and attached to the frame member to form a closed cross-section or a semi-closed cross-section with a portion of the open cross-section of at least a part of the frame member; and
a sound-absorbing member disposed in the closed cross-section or the semi-closed cross-section.

2. The vehicle structure according to claim 1, wherein the sound-absorbing member is attached to the liner member.

3. The vehicle structure according to claim 1, wherein the sound-absorbing member is attached to the frame member.

4. The vehicle structure according to claim 1, wherein the sound-absorbing member is attached to both the liner member and the frame member.

5. The vehicle structure according to claim 1, wherein the sound-absorbing member is configured to be disposed at a position overlapping the tire in a top view.

6. The vehicle structure according to claim 1, wherein the frame member is a frame portion extending along a vehicle front-rear direction in a wheelhouse.

7. The vehicle structure according to claim 6, wherein
the frame member includes two or more chambers partitioned by a rib in a vehicle-height direction, and
the sound-absorbing member is disposed in an upper chamber including at least a chamber located on an uppermost side in the vehicle-height direction among the two or more chambers.

8. The vehicle structure according to claim 7, wherein
the frame member includes two chambers partitioned by the rib in the vehicle-height direction, and
the sound-absorbing member is disposed in the chamber located on an upper side in the vehicle-height direction.

9. The vehicle structure according to claim 2, wherein the liner member includes a rib on a surface on a side where the sound-absorbing member is attached.
